(19) United States
(12) Patent Application Publication
(10) Pub. No.: US 2020/0296054 A1
(43) Pub. Date: Sep. 17, 2020

(54) METHOD AND SYSTEM FOR PROVIDING NETWORK RESOURCE SHARING IN MULTI-ACCESS EDGE COMPUTING (MEC) NETWORK

(71) Applicant: Wipro Limited, Bangalore (IN)

(72) Inventor: Manjari Asawa, Cupertino, CA (US)

(21) Appl. No.: 16/298,805

(22) Filed: Mar. 11, 2019

(51) Int. Cl. H04L 12/911; H04L 29/08

(52) U.S. Cl. CPC H04L 47/821; H04L 67/148; H04L 67/10

(57) ABSTRACT

The present disclosure discloses method and a resource managing system for providing network resource sharing in Multi-Access Edge Computing (MEC) network. The method includes receiving a network service request from an application via an application orchestrator. The resources required to serve the application are present in one of a plurality of MEC systems configured in the MEC network. Availability of the resources in each of the plurality of MEC systems is identified for serving network service request based on predefined parameters. A MEC system of the plurality of MEC systems capable of serving the network service request is recommended to application orchestrator based on the identification and optimization of performance or cost. The resources of the MEC system for serving the network service request is allocated upon receipt of a response to the recommendation from the application orchestrator, thereby providing network resource sharing in the MEC network.

### FIELD

The present subject matter is related in general to network resource management, more particularly, but not exclusively to a method and system for providing network resource sharing in Multi-Access Edge Computing (MEC) network.

### BACKGROUND

With advanced computer technologies, network computing has gained huge importance as well due to vast usage of network services by users. Typically, one desired goal of every network service provider may be to provide uninterrupted services with quality and efficiency to as many users as possible with minimal operational cost. To approach this goal, one way for the network service providers of different networks is to share resources. With introduction of Mobile Edge Computing (MEC) network, data load management and latency in networks is improved consistently. Currently, the MEC network may not include an explicit resource sharing mechanism for efficient usage of resources.

Today, mobile communication providers are facing diminishing Average Revenue Per User (ARPU) as well as increasing competition from Over the Top (OTT) players. Impeding move to Fifth generation (5G) communication technique requires substantial investment in mobile infrastructure, which is difficult for any individual operators. Hence, efficient mechanisms are required to share resources among multiple operators with dynamic and adaptive mechanism and clear policies to ensure a fair and safe sharing.

Today 5G has defined a new critical element for its operational and performance requirement, which is referred as Multi-access Edge Computing (MEC). Edge computing as an evolution of cloud computing typically brings application hosting from centralized data centres down to network edge, closer to consumers and data generated by applications. MEC integrates Network Functions Virtualization (NFV) based cloud computing environment with radio access network. Such integration not only provides benefits of aggregation and statistical gain of shared resources, but also allows better response time and throughput. Generally, many 5G services desire running application and services closer to users due to many reasons, such as, performance where propagation latency may cause problems, business reasons where cost of transmitting data is too expensive, and data should be processed locally, legal and security reasons where data should not leave premises.

Existing Mobile edge architecture typically includes a mobile host, a virtualization infrastructure, supporting services such as DNS, traffic rule policies, a mobile edge platform manager that allows running multiple mobile edge applications under guidance and support for centralized or distributed operations support system and orchestrator. Currently, though orchestrator and management interfaces exist, there is no explicit resource sharing mechanism among different service operators of same MEC resources over a time horizon. Also, there exist no concept of a resource hub to support sharing of available resources among different service operators. Hence, while multiple operators are desired to deploy the MEC infrastructure widely, the implementation of such infrastructure seems difficult due to operation and maintenance costs associated with the MEC infrastructure.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure may relate to a method for providing network resource sharing in Multi-Access Edge Computing (MEC) network. The method includes receiving a network service request from an application via an application orchestrator. The resources required to serve the application are present in one of a plurality of MEC systems configured in the MEC network. The method includes identifying availability of the resources in each of the plurality of MEC systems for serving the network service request based on predefined parameters. Based on the identification, recommending a MEC system of the plurality of MEC systems capable of serving the network service request to the application orchestrator. Thereafter, the method includes allocating the resources of the MEC system for serving the network service request upon receipt of a response to the recommendation from the application orchestrator, thereby providing network resource sharing in the MEC network.

In an embodiment, the present disclosure may relate to a resource managing server for providing network resource sharing in Multi-Access Edge Computing (MEC) network. The resource managing server may include a processor and a memory communicatively coupled to the processor, where the memory stores processor executable instructions, which, on execution, may cause the resource managing server to receive a network service request from an application via an application orchestrator. The resources required to serve the application are present in one of a plurality of MEC systems configured in the MEC network. The resource managing server may be configured to identify availability of the resources in each of the plurality of MEC systems for serving the network service request based on predefined parameters. Based on the identification, the resource managing server may be configured to recommend a MEC system of the plurality of MEC systems capable of serving the network service request to the application orchestrator. Thereafter, the resource managing server may be configured to allocate the resources of the MEC system for serving the network service request upon receipt of a response to the recommendation from the application orchestrator. Thus, network resource sharing in the MEC network is enabled.

In an embodiment, the present disclosure relates to a non-transitory computer readable medium including instructions stored thereon that when processed by at least one processor may cause a resource managing server to receive a network service request from an application via an application orchestrator. The resources required to serve the application are present in one of a plurality of MEC systems configured in the MEC network. The instruction causes the processor to identify availability of the resources in each of the plurality of MEC systems for serving the network service request based on predefined parameters. Based on the identification, the instruction causes the processor to recommend a MEC system of the plurality of MEC systems capable of serving the network service request to the application orchestrator. Thereafter, the instruction causes the processor to allocate the resources of the MEC system for serving the network service request upon receipt of a response to the recommendation from the application orchestrator. Thus, network resource sharing in the MEC network is enabled.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for providing network resource sharing in Multi-Access Edge Computing (MEC) network in accordance with some embodiments of the present disclosure;

FIG. 2 shows a detailed block diagram of a resource managing server in accordance with some embodiments of the present disclosure;

FIG. 3 illustrates an exemplary representation of providing network resource sharing in Multi-Access Edge Computing (MEC) network in accordance with some embodiments of present disclosure;

FIG. 4 illustrates a flowchart showing a method for providing network resource sharing in Multi-Access Edge Computing (MEC) network in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises... a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relates to a method and a resource managing server for providing network resource sharing in Multi-Access Edge Computing (MEC) network. In an embodiment, the MEC network is an architecture which enables cloud computing capabilities and IT service environment at edge of the cellular network. The present disclosure provides a resource sharing environment in the MEC network. Typically, the resource managing server may identify resources available in a plurality of MEC systems configured in the MEC network on receiving any network service request from an application. The availability of the resources may be identified based on predefined parameters for serving the network service request. A MEC system of the plurality of MEC systems may be recommended which may be capable of serving the network service. Thereafter, the resources of the recommended MEC system may be allocated for serving the network service request. The present disclosure provides a resource sharing architecture for the MEC network which is flexible and extensible.

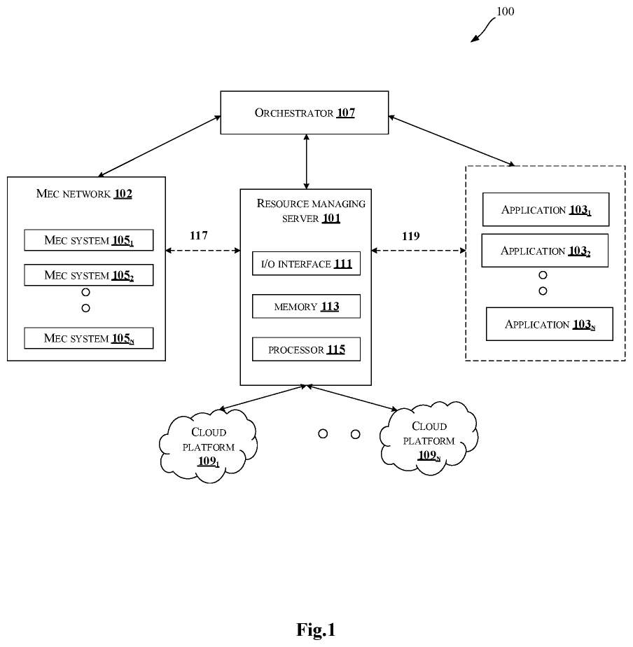

FIG. 1 illustrates an exemplary environment for providing network resource sharing in Multi-Access Edge Computing (MEC) network in accordance with some embodiments of the present disclosure.

As shown in FIG. 1, an environment 100 includes a resource managing server 101 connected through an orchestrator 107 to an MEC network 102 and an application 103₁, an application 103₂, and an application 103_{N} (collectively referred as plurality of applications 103). The resource managing server 101 may be connected to the MEC network 102 and the plurality of applications 103 directly using Application Programming Interface (API) 117 and API 119 respectively. Further, the resource managing server 101 may also be connected to a cloud platform 109₁, cloud platform 109n. In an embodiment, the plurality of applications 103 may be associated with respective application orchestrators (not shown explicitly in FIG. 1). In an embodiment, the plurality of applications 103 may be related to any type of services depending on type and organisation such as, enforcement agency, manufacturing industries and the like. The MEC network 102 includes a MEC system 105₁, a MEC system 105₂, and a MEC system 105_{N} (collectively referred as plurality of MEC systems 105). In an embodiment, each of the plurality of MEC systems 105 may be associated with one or more service providers. Further, each of the plurality of MEC systems 105 contains resources which may be used for sharing.

The plurality of MEC systems 105 may provide respective resources to associated one or more applications. In an embodiment, the resources may include such as, data and hardware devices which can be accessed and shared. A person skilled in the art would understand that any other type of resources, which may be shared and not mentioned explicitly may also be present in the present disclosure. In an embodiment, the plurality of MEC systems 105 may be a part of a base station, network core and design may be customized for each service provider. In an embodiment, the resource managing server 101 and the plurality of MEC systems 105 may communicate via various mechanism, such as message based on API. In an embodiment, the orchestrator 107 may manage interconnections and interactions among the resource managing server 101 with the MEC network 102 and the plurality of applications 103.

The resource managing server 101 may facilitate in sharing network resources in the MEC network 102. In one embodiment, the resource managing server 101 may include any other computing devices. Further, the resource managing server 101 may include an I/O interface 111, a memory 113 and a processor 115. The I/O interface 111 may be configured to receive a network service request through the orchestrator 107 from the plurality of applications 103. The network service request received from the I/O interface 111 may be stored in the memory 113. The memory 113 may be communicatively coupled to the processor 115 of the resource managing server 101. The memory 113 may also store processor instructions which may cause the processor 115 to execute the instructions for providing network resource sharing in Multi-Access Edge Computing (MEC) network. In an embodiment, the resource managing server 101 may be implemented with predefined Application Programming Interfaces (APIs). In an embodiment, the resource managing server 101 may be implemented in for example, by any message exchange mechanism via message queues, via a bridge which continuously merges messages, a graph database and ontology-based mapping to capture relationship among the plurality of MEC systems 105 and the plurality of applications 103 and the like.

Typically, each of the plurality of MEC systems 105 may periodically provide a list of respective available resources along with cost of usage of each resources to the resource managing server 101. Whenever, the resource managing server 101 receives any network service request from an application from the plurality of applications 103, the resource managing server 101 may refer to the list of available resources. In an embodiment, the network service request may be served by resources present in one of the plurality of MEC systems 105. On receiving the network service request, the resource managing server 101 may identify availability of the resources in each of the plurality of MEC systems 105 based on predefined parameters. In an embodiment, usage and control of the resources associated with each of the plurality of MEC systems 105 may be based on respective predetermined set of policies defined by respective MEC operator. In an embodiment, the predefined parameters may include location of served user, application, a priority of the network service request, one or more network services currently provided by each of the plurality of MEC systems 105 and a priority associated with each of the one or more network services currently being served. Further, based on the availability of the resources, the resource managing server 101 may recommend an MEC system of the plurality of MEC systems 105 which may be capable of serving the network service request to the application through the orchestrator 107.

In an embodiment, the recommendation may be provided by identifying a priority of the network service request and determining availability of the resources of the MEC system required for serving the network service request. Further, one or more existing network services being served by the resources of the MEC system may be migrated in order to serve the network service request. In an embodiment, recommendation includes cost associated with usage of the resources. Thereafter, the resource managing server 101 may allocate the resources of the MEC system for serving the network service request. The resources may be allocated upon receipt of a response to the recommendation from the application. In an embodiment, the resource managing server 101 may monitor performance of the MEC system serving the network service request of the application. In an embodiment, based on the monitoring, the resource managing server 101 may receive a request periodically for the list of available resources of the plurality of MEC systems from the application through orchestrator 107. In case, the performance monitored for the MEC system is an issue, the resource managing server 101 may reselect an MEC system for serving the network service request based on cost of the MEC recommended previously and cost of usage of other plurality of MEC systems.

In case of availability of MEC system from the other plurality of MEC systems with comparatively lesser cost of usage, the resource managing server 101 may migrate the application to the reselected MEC system for serving the network service request. Further, in an embodiment, the resource managing server 101 may receive the network service request from one or more applications via respective application orchestrator through the orchestrator 107. In such case, the resource managing server 101 may provide the list of available resources along with corresponding cost of usage to each one or more applications through the orchestrator 107. The orchestrator 107 may select a resource for each of the one or more applications from the list of available resources depending on the network service request and the cost of usage. Further, the resource managing server 101 may deploy each of the one or more application at one of an MEC system of the plurality of MEC systems 105 associated with the selected resource and one of the cloud platform 109.

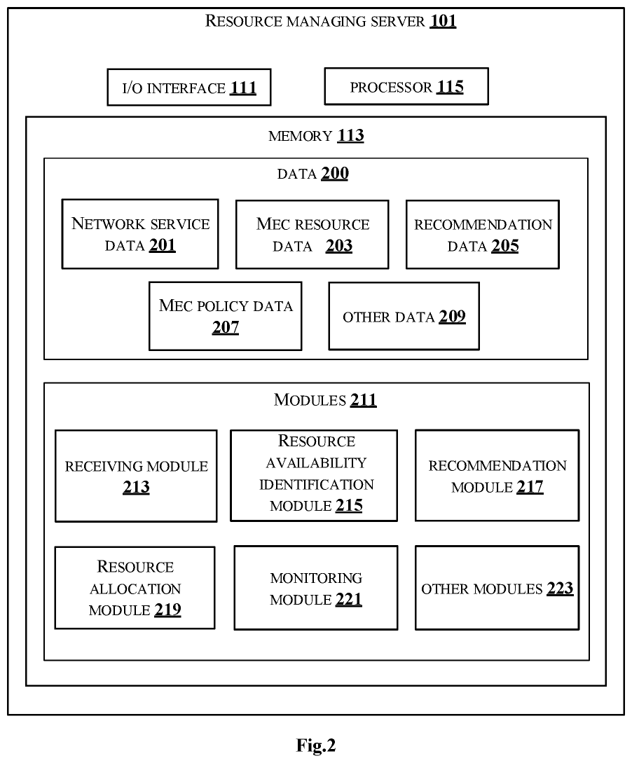

FIG. 2 shows a detailed block diagram of a resource managing server in accordance with some embodiments of the present disclosure.

The resource managing server 101 may include data 200 and one or more modules 211 which are described herein in detail. In an embodiment, data 200 may be stored within the memory 113. The data 200 may include, for example, network service data 201, MEC resource data 203, recommendation data 205, MEC policy data 207 and other data 209.

The network service data 201 may include the network service request received from the plurality of applications 103. In an embodiment, the network service request may be for sharing resources required for functioning of the application.

The MEC resource data 203 may include details regarding the resources present in each of the plurality of MEC systems 105. The details may include, but not limited to, the list of available resources present with the plurality of MEC systems 105 along with the cost involved in using the available resources.

The recommendation data 205 may include details of the MEC system which may be recommended for the plurality of applications103. In an embodiment, the recommendation data 205 may also include details regarding the performance of the MEC system recommended for the application.

The MEC policy data 207 may include the predetermined set of policies associated with each of the plurality of MEC systems 105. In an embodiment, the predetermined set of policies specifies permissions to restrict or prioritize access to resources by the plurality of applications 103. The restriction may be for example, with regards to amount of resources to be reserved for radio baseband computation to handle fluctuating traffic demands, amount of resources to be reserved for emergency services and the like. For example, a policy may be that while an application, for instance “A” can utilise the resources in an MEC system say “M”, an application “B” may be allowed to use the resources, only if, current utilization of the resources of the MEC system “M” is less than 60%. While an application “C” is not allowed to use resources of the MEC system “M”. In an embodiment, the set of policies may be identity-based or resource-based or a combination of the two.

The other data 209 may store data, including temporary data and temporary files, generated by modules 211 for performing the various functions of the resource managing server 101.

In an embodiment, the data 200 in the memory 113 are processed by the one or more modules 211 present within the memory 113 of the resource managing server 101. In an embodiment, the one or more modules 211 may be implemented as dedicated units. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. In some implementations, the one or more modules 211 may be communicatively coupled to the processor 115 for performing one or more functions of the resource managing server 101. The said modules 211 when configured with the functionality defined in the present disclosure will result in a novel hardware.

In one implementation, the one or more modules 211 may include, but are not limited to a receiving module 213, a resource availability identification module 215, a recommendation module 217, a resource allocation module 219 and a monitoring module 221. The one or more modules 211 may also include other modules 223 to perform various miscellaneous functionalities of resource managing server 101. In an embodiment, the other modules 223 may include a policy creation module which may create the predetermined set of policies for each of the plurality of MEC systems 105. In an embodiment, the set of policies may define permissions to restrict or prioritize access to the resources by different types of applications. For example, a policy may be that while an application, for instance “A” can utilise the resources in an MEC system say “M”, an application “B” may be allowed to use the resources, only if, current utilization of the resources of the MEC system “M” is less than 60%. While an application “C” is not allowed to use resources of the MEC system “M”. Further, the other modules 223 may include a migration module which may migrate one or more application from one MEC system to other MEC system based on one or more instructions. Further, the migration module may migrate the application to a reselected MEC system based on monitoring for serving the network service request.

The receiving module 213 may receive the network service request from the application of the plurality of applications 103 via respective application orchestrator. Further, the receiving module 213 may receive the list of available resources from each of the plurality of MEC systems 105.

The resource availability identification module 215 may identify availability of the resources in each of the plurality of MEC systems 105 for serving the network service request. The availability of the resources may be identified based on the predefined parameters which may include location of served user, the application, the priority of the network service request, the one or more network services currently provided by each of the plurality of MEC systems 105 and the priority associated with each of the one or more network services currently being served. For instance, let “A” be an application, R_{A} be total number of virtual machines for the application “A” which may be required to run the application. Let “N_{VA}” denotes number of virtual machine for type “V” for the application “A”. Further, the MEC with available resources to run the virtual machine of type “V” or possible cloud locations is denoted by “S_{V}”.

The recommendation module 217 may recommend the MEC system of the plurality of MEC systems 105 which is capable of serving the network service request to the application orchestrator 107. The recommendation module 217 may identify the priority of the network service request and determines the availability of the resources of the MEC system required for serving the network service request. Further, the recommendation module 217 may indicate the migrating module as described above to migrate the one or more existing network services which may be served by the resources of the MEC system in order to serve the network service request. In an instance, when the network service request is received from one or more applications via respective application orchestrator, the list of available resources along with corresponding cost of usage is provided to each application orchestrator associated with the one or more applications. On providing the list of available resource, the resource may be selected by each of the one or more applications depending on the network service request and the cost of usage. For instance, let “A” be an application, R_{A} be total number of virtual machines for the application “A” which may be required to run for the application. Let “N_{VA}” denotes number of virtual machine for type “V” for the application “A”. Further, a feasible set of MEC with available resources to run the virtual machine of type “V” or possible cloud locations is denoted by “S_{V}”. When running the virtual machine of type “V” in location “L”

(MEC or cloud), the performance achieved may be donated by P_{YL}.

In such case, the recommendation module 217 may recommend the resource for all the virtual machines of one or more application in order to maximize resource utilization as represented by equation 1 below, subject to a constraint that virtual machine of type “V” are in a location that is member of set “S_{V}”.

$${Σ}_{A} {Σ}_{RA} ( \text{?} * {P}_{VL} ) \text{?} \text{indicates text missing or illegible when filed} \qquad ( 1 )$$

The recommendation module 217 may also provide the cost associated with usage of the resources. The MEC system and the cost of the usage of the resources of the recommended MEC system may be indicated to respective application orchestrator via the orchestrator 107. Thus, the application orchestrator of the application may select the MEC system and provide the response to the recommendation module 217. For instance, consider an example where, let “R” denote total number of virtual machines for the application “A”, let “N_{VA}” denotes number of virtual machine of type “V” for the application “A”. Let cost of running “V” in location L, is C_{VL}, such case, the recommendation module 217 may recommend resources considering the cost of usage in order to minimize equation 2 as shown below.

$$\text{?} ( \text{?} * {C}_{VL} ) \\ \text{?} \text{indicates text missing or illegible when filed} \qquad ( 2 )$$

Further, the recommendation module 217 may receive indication from the monitoring module 221 regarding the performance of the recommended MEC system. In such case, the recommendation module 217 may reselect the MEC system for serving the network service request based on the performance and cost of the MEC system recommended previously and cost of usage of other plurality of MEC systems.

The resource allocation module 219 may provide the resources of the MEC system for serving the network service request upon receipt of the response to the recommendation from the application orchestrator. Further, the resource allocation module 219 may deploy each of the one or more application at either the MEC system of the plurality of MEC systems 105 associated with the selected resource or the corresponding cloud platform 109.

The monitoring module 221 may monitor the performance of the MEC system which may be serving the network service request of the application. Typically, outcome of the monitoring may be provided to the application orchestrator of the application. Based on the outcome, the request for the list of available resources of the plurality of MEC systems 105 may be received from the application orchestrator for serving the network service request. In an embodiment, the performance of the MEC system may be monitored by considering a predefined threshold range. For example, a transaction response time of more than one seconds may be considered unacceptable. In case the performance is beyond the predefined threshold range, the monitoring module 221 may provide the indication to the recommendation module 217 for reselection of the MEC system for serving the network service request.

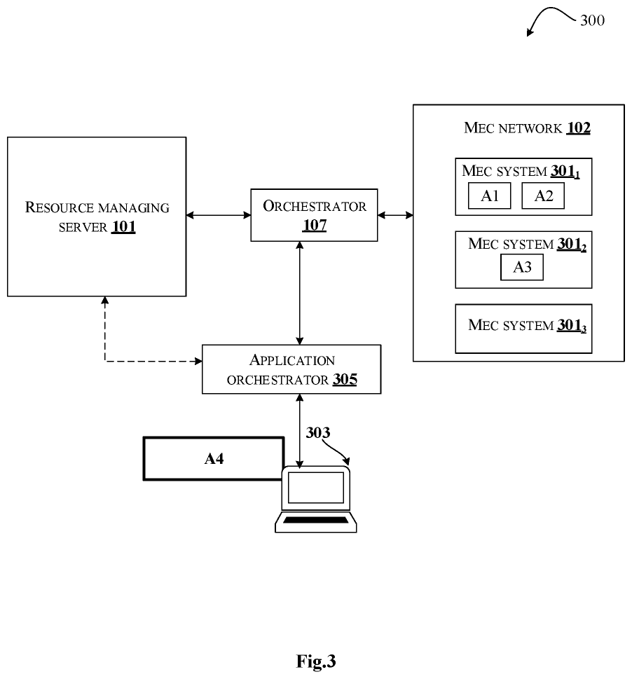

FIG. 3 illustrates an exemplary representation of providing network resource sharing in Multi-Access Edge Computing (MEC) network in accordance with some embodiments of present disclosure.

Referring now to FIG. 3, an exemplary representation 300 for resource sharing is illustrated. The exemplary representation 300 includes the resource managing server 101 connected through the orchestrator 107 to the MEC network 102. The MEC network 102 includes three MEC system namely, MEC system 301₁, a MEC system 301₂ and an MEC system 303₃. FIG. 3 is an exemplary representation and the MEC network 102 may include the plurality of MEC systems. Consider, the MEC system 301₁ is currently running and serving an application A1 and an application A2 of a priority say, P2 for user devices (not shown explicitly in FIG. 3). Further, the MEC system 301₂ is currently running and serving an application A3. For instance, a user device 303 reaches to the resource managing server 101 for a network service request for the application A4 through respective application orchestrator 305. A logical connection between the resource managing server 101 and the application orchestrator 305 is represented by a dotted line. Consider, the user device 303 belongs to a law enforcement agency and requires service for the application A4 of priority, say, P1 (whose priority is higher than P2), from the MEC system 301₁ due to a gun incidence which may be occurred near area served by the MEC system 301₁.

Thus, in such case, the application A4 of the user device 303 sends a network service request to the resource managing server 101 along with priority indication of, P1 and desired location of MEC system 301₁. The resource managing server 101 may check and identity the list of resources associated with the MEC 301₁. The MEC 301₁ is serving the applications A1 and A2 of priority P2 and may not contain enough resources for serving the application A4 of high priority P1. In such case, the resource managing server 101 may indicate resource constraint condition at the MEC system 301₁ to the user devices associated with the application A1 and A2. Further, the resource managing server 101 may recommend resources in the MEC system 301₂ and MEC system 301₃ as alternative. In an embodiment, the resource managing server 101 may also offer incentive in terms of a reward or lower price for running the application A1 and A2 in the MEC system 301₂ and MEC system 301₃. Consider, on receiving the indication, the application A2 and A1 may accept the offer to migrate the services to the MEC system 301₂ and MEC system 301₃ respectively. In such case, the resource managing server 101 may inform the orchestrator 107 which may in turn orchestrates movement of application Al and A2 from MEC 301₁ to MEC 301₂ and MEC system 301₃ respectively. Further, the resource managing server 101 may provide resource of the MEC system 301₁ to the application A4.

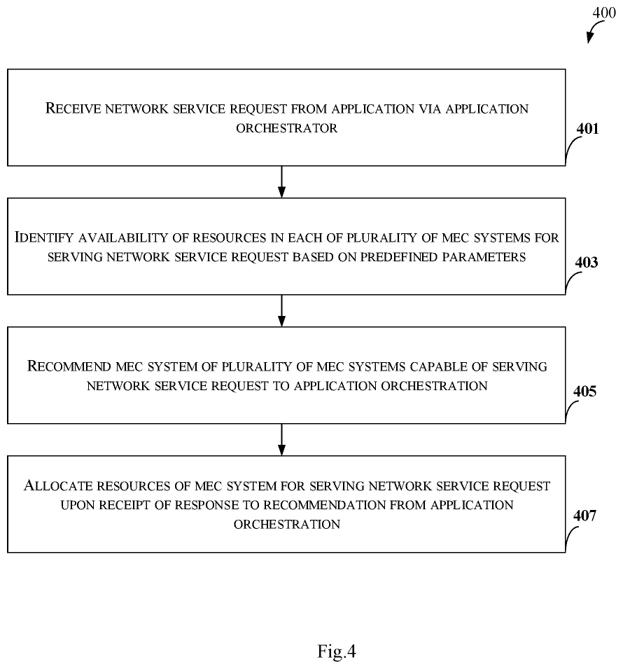

FIG. 4 illustrates a flowchart showing a method for providing network resource sharing in Multi-Access Edge Computing (MEC) network in accordance with some embodiments of present disclosure.

As illustrated in FIG. 4, the method 400 includes one or more blocks for providing network resource sharing in Multi-Access Edge Computing (MEC) network. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the network service request is received by the receiving module 213 from the application via application orchestrator. In an embodiment, the resources required to serve the application are present in one of the plurality of MEC systems 105.

At block 403, the availability of the resources in each of the plurality of MEC systems 105 is identified by the resource availability identification module 215 for serving the network service request based on the predefined parameters. In an embodiment, the predefined parameters include location of served user, application, the priority of the network service request, one or more network services currently provided by each of the plurality of MEC systems and the priority associated with each of the one or more network services currently being served.

At block 405, the MEC system of the plurality of MEC systems 105 which is capable of serving the network service request may be recommended by the recommendation module 217 to the application orchestrator.

At block 407, the resources of the MEC system is allocated by the resource allocation module 219 for serving the network service request upon receipt of the response to the recommendation from the application orchestrator.

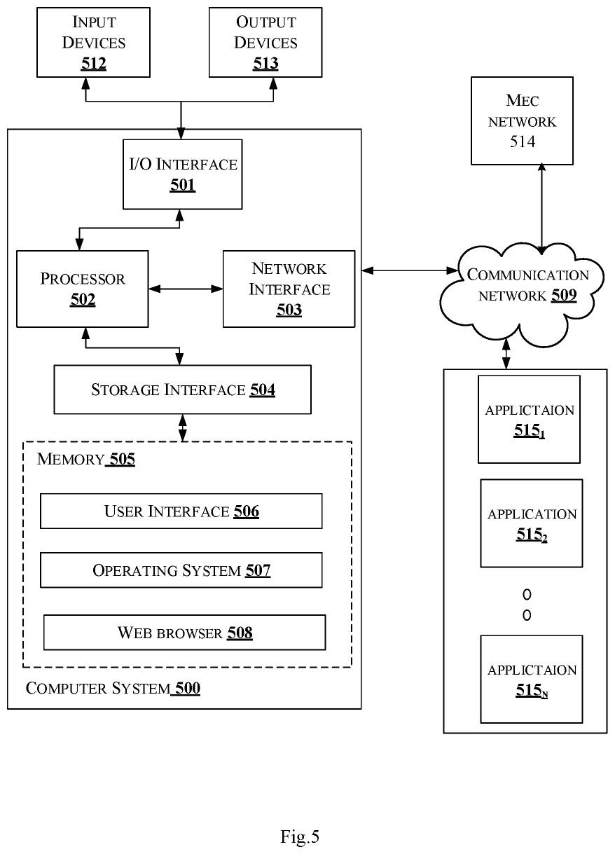

FIG. 5 illustrates a block diagram of an exemplary computer system 500 for implementing embodiments consistent with the present disclosure. In an embodiment, the computer system 500 may be used to implement the resource managing server 101. The computer system 500 may include a central processing unit (“CPU” or “processor”) 502. The processor 502 may include at least one data processor for providing network resource sharing in Multi-Access Edge Computing (MEC) network. The processor 502 may include specialized processing units such as, integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices such as input devices 512 and output devices 513. For example, the input devices 512 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output devices 513 may be a printer, fax machine, video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 500 consists of the resource managing server 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with an MEC network 514 and an application 515₁, an application 515₂, and an application 515_{N} (collectively referred as 515). The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, APPLE MACINTOSH^{R} OS X, UNIX^{R}, UNIX-like system distributions (E.G., BERKELEY SOFTWARE DISTRIBUTION™ (BSD), FREEB SD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE^{R} IOS™, GOOGLE^{R} ANDROID™, BLACKBERRY^{R} OS, or the like.

In some embodiments, the computer system 500 may implement a web browser 508 stored program component. The web browser 508 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 708 may utilize facilities such as AJAX™, DHTML™, ADOBE® FLASH™, JAVASCRIPT™, JAVA™, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

An embodiment of the present disclosure is widely applicable in various contexts, from MEC provided by private 5G operators to MECs provided by mobile wireless operators.

An embodiment of the present disclosure provides a dynamic resource sharing platform with an ability to lease out resources. The applications can be made adaptive to the availability, application characteristics and also possibly of pricing to allow optimal efficiency and flexible business models.

An embodiment of the present disclosure allows operator to lease out MEC resources as additional revenue stream.

In an embodiment of the present disclosure cost to install and maintain MEC is managed, thereby improving customer experience by sharing MECs which can cover high-volume, high-traffic areas better and closer to the customer thereby providing reduced latency.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals,

Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of providing network resource sharing in Multi-Access Edge Computing (MEC) network, the method comprising:
receiving, by a resource managing server, a network service request from an application via an application orchestrator, wherein resources required to serve the application are present in one of a plurality of MEC systems configured in the MEC network;
identifying, by the resource managing server, availability of the resources in each of the plurality of MEC systems for serving the network service request based on predefined parameters, wherein the predefined parameters comprise location of served user, application, a priority of the network service request, one or more network services currently provided by each of the plurality of MEC systems and a priority associated with each of the one or more network services currently being served, and by referring to a list of available resources periodically received along with associated cost of usage for each of the available resources:
recommending, by the resource managing server, a MEC system of the plurality of MEC systems capable of serving the network service request to the application orchestrator based on the identification; and
allocating, by the resource managing server, the resources of the MEC system for serving the network service request upon receipt of a response to the recommendation from the application orchestrator, thereby providing network resource sharing in the MEC network.

2. The method as claimed in claim 1, wherein each of the plurality of MEC systems is associated with one or more service providers.

6. (canceled)

4. The method as claimed in claim 1, wherein recommending the MEC system capable of serving the network service request to the application orchestrator comprises:
identifying, the resource managing server, a priority of the network service request;
determining, by the resource managing server, availability of the resources of the MEC system required for serving the network service request;
migrating, by the resource managing server, one or more existing network services being served by the resources of the MEC system in order to serve the network service request.

5. The method as claimed in claim 1, wherein recommending further comprises providing cost associated with usage of the resources.

6. (canceled)

7. The method as claimed in claim 1 further comprising:
monitoring performance of the MEC system serving the network service request of the application.

8. The method as claimed in claim 1 further comprising:
receiving, by the resource managing server, a list of available resources along with corresponding cost of usage from the plurality of MEC systems;
receiving, by the resource managing server, the network service request from one or more applications via respective application orchestrator;
providing, by the resource managing server, the list of available resources along with corresponding cost of usage to each application orchestrator associated with the one or more applications, wherein a resource from the list of available resources is selected by each of the one or more applications depending on the network service request and the cost of usage;
deploying, by the resource managing server, each of the one or more application at one of, an MEC system of the plurality of MEC systems associated with the selected resource and corresponding cloud platform.

9. The method as claimed in claim 7 further comprising:
receiving a request periodically for a list of available resources of the plurality of MEC systems from the application orchestrator based on the monitoring, for serving the network service request;
reselecting an MEC system for serving the network service request based on the performance and cost of the MEC recommended previously and cost of usage of other plurality of MEC systems; and
migrating the application to the reselected MEC system for serving the network service request,

10. A resource managing server for providing network service sharing in Multi-Access Edge Computing (MEC) network, comprising:
a processor; and
a memory communicatively coupled to the processor, wherein the memory stores processor instructions, which, on execution, causes the processor to:
receive a network service request from an application via an application orchestrator, wherein resources required to serve the network service request is present in one of a plurality of MEC systems configured in the MEC network;
identify availability of the resources in each of the plurality of MEC systems for serving the network service request based on predefined parameters, wherein the predefined parameters comprise location of served user, application, a priority of the network service request, one or more network services currently provided by each of the plurality of MEC systems and a priority associated with each of the one or more network services currently being served, and by referring to a list of available resources periodically received along with associated cost of usage for each of the available resources;
recommend a MEC system of the plurality of MEC systems capable of serving the network service request to the application orchestrator based on the identification; and
allocate the resources of the MEC system for serving the network service request upon receipt of a response to the recommendation from the application orchestrator, thereby providing network resource sharing in the MEC network.

11. The resource managing server as claimed in claim 10, wherein each of the plurality of MEC systems is associated with one or more service providers,

12. (canceled)

13. The resource managing server as claimed in claim 10, wherein the processor recommends the MEC system capable of serving the network service request to the application orchestrator by:
identifying a priority of the network service request;
determining availability of the resources of the MEC system required for serving the network service request;
migrating one or more existing network services being served by the resources of the MEC system in order to serve the network service request.

14. The resource managing server as claimed in claim 10, wherein the processor recommends cost associated with usage of the resources.

15. (canceled)

16. The resource managing server as claimed in claim 10, wherein the processor monitors performance of the MEC system serving the network service request of the application.

17. The resource managing server as claimed in claim 10, wherein the processor:
receives a list of available resources along with corresponding cost of usage from the plurality of MEC systems;
receiving, by the resource managing server, the network service request from one or more applications via respective application orchestrator;
provides the list of available resources along with corresponding cost of usage to each application orchestrator associated with the one or more applications, wherein a resource from the list of available resources is selected by each of the one or more applications depending on the network service request and the cost of usage;
deploys each of the one or more application at one of, an MEC system of the plurality of MEC systems associated with the selected resource and corresponding cloud platform.

18. The resource managing server as claimed in claim 16, wherein the processor:
receives a request periodically for a list of available resources of the plurality of MEC systems from the application orchestrator based on the monitoring, for serving the network service request;
reselects an MEC system for serving the network service request based on the performance and cost of the MEC recommended previously and cost of usage of other plurality of MEC systems; and
migrates the application to the reselected MEC system for serving the network service request.

19. A non-transitory computer readable medium including instructions stored thereon that when processed by at least one processor cause a resource managing server to perform operations comprising:
receiving a network service request from an application via an application orchestrator, wherein resources required to serve the application are present in one of a plurality of MEC systems configured in the MEC network;
identifying availability of the resources in each of the plurality of MEC systems for serving the network service request based on predefined parameters, wherein the predefined parameters comprise location of served user, application, a priority of the network service request. one or more network services currently provided by each of the plurality of MEC systems and a priority associated with each of the one or more network services currently being served, and by referring to a list of available resources periodically received along with associated cost of usage for each of the available resources:
recommending a MEC system of the plurality of MEC systems capable of serving the network service request to the application orchestrator based on the identification; and
allocating the resources of the MEC system for serving the network service request upon receipt of a response to the recommendation from the application orchestrator, thereby providing network resource sharing in the MEC network.
